(19) United States
(12) Patent Application Publication
(10) Pub. No.: US 2025/0131433 A1
(43) Pub. Date: Apr. 24, 2025

(54) ARTIFICIAL-INTELLIGENCE-ENABLED INFORMATION SECURITY TECHNIQUES BASED ON USER METADATA

(71) Applicant: MASTERCARD TECHNOLOGIES CANADA ULC, Vancouver (CA)

(72) Inventors: Kyle Williams, Wentzville, MO (US); Jonathan McGrandle, Maple Ridge (CA); Matthew Melnik, Delta (CA)

(21) Appl. No.: 18/490,023

(22) Filed: Oct. 19, 2023

(51) Int. Cl. G06Q 20/40

(52) U.S. Cl. CPC G06Q 20/40145; G06Q 20/407

(57) ABSTRACT

A system includes memory hardware configured to store instructions and one or more electronic processors configured to execute the instructions. The instructions include receiving historical behavioral biometric metadata from a plurality of computing platforms to build a historical profile, training a machine learning model using the historical profile, receiving a transaction request from a first computing platform, the transactional request including first behavioral biometric metadata, providing the first behavioral biometric metadata and the historical behavioral biometric metadata to the trained machine learning model to generate a biometric match, generating a control signal based on the biometric match, and sending the control signal to a second computing platform.

### FIELD

The present disclosure relates to information security techniques and, more particularly, to artificial-intelligence-enabled information security techniques based on machine-captured metadata.

### SUMMARY

Detecting fraudulent transactions-such as fraudulent credit card transactions-on the Internet presents a variety of significant technical challenges. Millions of online credit card transactions take place every day across millions of different merchant platforms. This sheer volume makes it difficult to monitor and analyze each transaction, much less in real-time or near-real time. For example, the Internet is accessed via a multitude of different types of devices, including smartphones, tablets, laptops, and desktops. Each device has unique characteristics that range from its operating system (such as iOS, Android, Windows, macOS, or one of a multitude of different Linux distributions) to its device ID. The diversity of devices and software platforms can generate a vast array of different and unconnected transaction behaviors, which can make it challenging to set consistent logical rules for detecting fraudulent behavior. For example, what might be normal transactional behavior on a desktop computer could be deemed suspicious on a smartphone.

Similarly, each device can have multiple browsers, and each browser can have multiple versions. The behavior of a user might differ from one browser to another (and from one version to another), which adds another layer of complexity to any logical rule development process. Furthermore, graphical user interfaces can vary dramatically between different merchant platforms, web browsers, and apps (and even within different versions of the same web browser or app). These variations can influence user behavior in ways that complicate setting logical rules for fraud detection. In summary, the sheer diversity of devices, software, and graphical user interfaces (e.g., at merchant platforms) makes it challenging to develop logical rules that consistently and accurately distinguish between fraudulent transactions and legitimate ones. Thus, what is needed are techniques for detecting fraudulent transactions that can scale across a wide range of different devices, software, and merchant platforms that do not require users to set logical rules in advance.

In some embodiments, a system includes memory hardware configured to store instructions and one or more electronic processors configured to execute the instructions. The instructions include receiving historical behavioral biometric metadata from a plurality of computing platforms to build a historical profile, training a machine learning model using the historical profile, receiving a transaction request from a first computing platform, the transactional request including first behavioral biometric metadata, providing the first behavioral biometric metadata and the historical behavioral biometric metadata to the trained machine learning model to generate a biometric match, generating a control signal based on the biometric match, and sending the control signal to a second computing platform.

In other features, the instructions include updating the historical profile using the first behavioral biometric metadata and retraining the trained machine learning model using the updated historical profile. In other features, providing the first behavioral biometric metadata and the historical behavioral biometric metadata to the trained machine learning model to generate the biometric match includes providing the first behavioral biometric metadata to the trained machine learning model to generate a first output, providing the historical profile to the trained machine learning model to generate a reference output, and computing a closeness of the first output and the reference output.

In other features, providing the first behavioral biometric metadata and the historical behavioral biometric metadata to the trained machine learning model to generate the biometric match includes, in response to the closeness not exceeding a threshold, generating a negative biometric match. In other features, providing the first behavioral biometric metadata and the historical behavioral biometric metadata to the trained machine learning model to generate the biometric match includes, in response to the closeness meeting or exceeding the threshold, generating a positive biometric match.

In other features, the instructions include retrieving the historical profile based on an identifier contained in the transactional request. In other features, the first behavioral biometric metadata includes keystroke metadata. In other features, the first behavioral biometric metadata includes touchscreen metadata. In other features, the first behavioral biometric metadata includes mouse metadata. In other features, the first behavioral biometric metadata includes accelerometer metadata.

In other examples, a computer-implemented method includes receiving historical behavioral biometric metadata from a plurality of computing platforms to build a historical profile, training a machine learning model using the historical profile, receiving a transaction request from a first computing platform, the transactional request including first behavioral biometric metadata, providing the first behavioral biometric metadata and the historical behavioral biometric metadata to the trained machine learning model to generate a biometric match, generating a control signal based on the biometric match, and sending the control signal to a second computing platform.

In other features, the method includes updating the historical profile using the first behavioral biometric metadata and retraining the trained machine learning model using the updated historical profile. In other features, providing the first behavioral biometric metadata and the historical behavioral biometric metadata to the trained machine learning model to generate the biometric match includes providing the first behavioral biometric metadata to the trained machine learning model to generate a first output, providing the historical profile to the trained machine learning model to generate a reference output, and computing a closeness of the first output and the reference output.

Other examples, embodiments, features, and aspects will become apparent by consideration of the detailed description and accompanying drawings.

### BRIEF DESCRIPTION OF THE DRAWINGS

FIG. 1 is a functional block diagram of an example system for detecting fraudulent transactions based on user interactions with a graphical user interface.

FIG. 2 is an example graphical user interface generated by a merchant platform.

FIG. 3 is a flowchart of an example process for training a machine learning model using behavioral biometric metadata.

FIG. 4 is a flowchart of an example process for generating a training dataset from logged behavioral biometric metadata.

FIGS. 5A-5B are flowcharts of an example process for training a machine learning model using a training dataset.

FIG. 6 is a message sequence chart showing example interactions between components of a system for authenticating a transaction based on behavioral biometric metadata.

FIG. 7 is a message sequence chart showing example interactions between components of a system for authenticating a chargeback request using behavioral biometric metadata.

FIG. 8 is a message sequence chart showing example interactions between components of a system for authenticating a chargeback request using behavioral biometric metadata.

FIGS. 9A-9B are flowcharts of an example process for performing a biometric match using a machine learning model.

### DETAILED DESCRIPTION

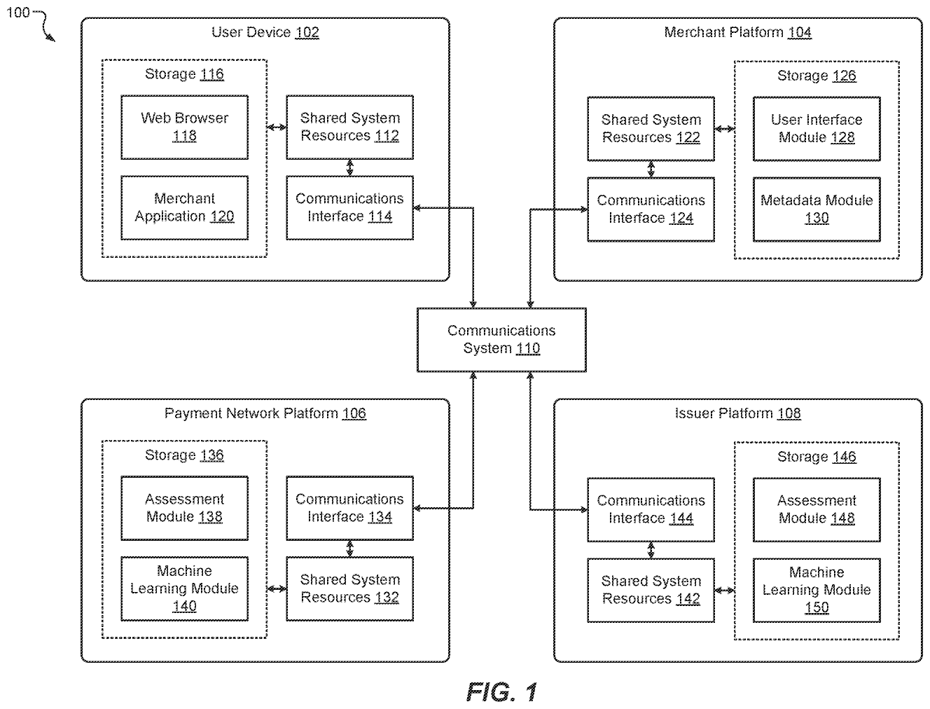

FIG. 1 is a functional block diagram of an example system 100 for detecting fraudulent transactions based on user interactions with a graphical user interface. In some embodiments, system 100 includes a user device 102, a merchant platform 104, a payment network platform 106, and an issuer platform 108. The user device 102, merchant platform 104, payment network platform 106, and issuer platform 108 may communicate via a communications system 110. Examples of the communications system 110 include one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In various implementations, the communications system 110 includes an optical network, a local area network, and/or a global communication network, such as the Internet.

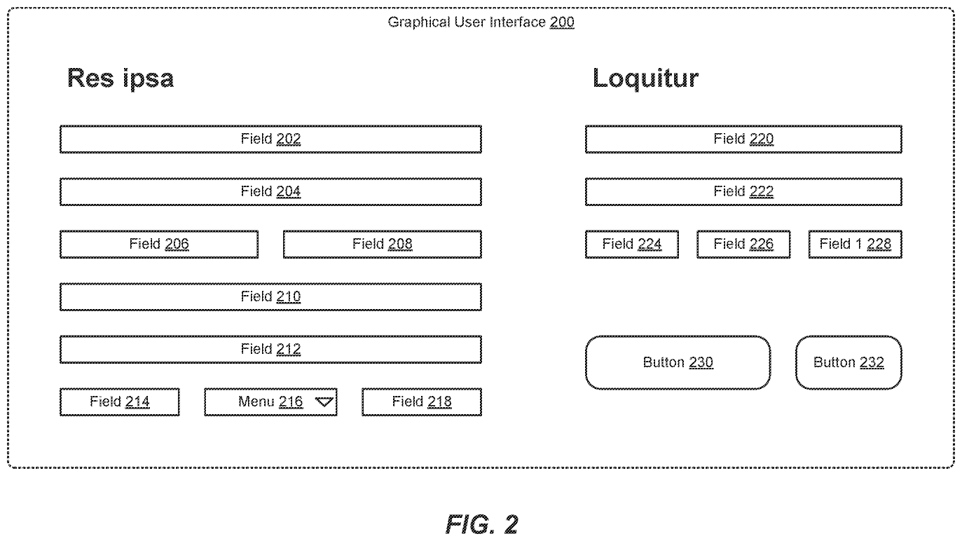

In some examples, the user device 102 may include any device for accessing the Internet, such as a smartphone, tablet, laptop, desktop, or other suitable device. For example, the user device 102 includes shared system resources 112, communications interface 114, and/or one or more data stores that include non-transitory computer-readable storage media, such as storage 116. Shared system resources 112 may include one or more electronic processors, one or more graphics processing units, volatile computer memory, non-volatile computer memory, and/or one or more system buses connecting components of shared system resources 112, communications interface 114, and/or storage 116. In various implementations, storage 116 includes one or more software modules, such as web browser 118 and/or merchant application 120. Additional functionality of web browser 118 and merchant application 120 will be described further on in this specification with reference to FIGS. 2-9B.

In some examples, merchant platform 104 includes shared system resources 122, communications interface 124, and/or one or more data stores that include non-transitory computer-readable storage media, such as storage 126. Shared system resources 122 may include one or more electronic processors, one or more graphics processing units, volatile computer memory, non-volatile computer memory, and/or one or more system buses connecting components of shared system resources 122, communications interface 124, and/or storage 126. In some embodiments, storage 126 includes one or more software modules, such as user interface module 128 and/or metadata module 130. Additional functionality of user interface module 128 and metadata module 130 will be described further on in this specification with reference to FIGS. 2-9B.

In various implementations, payment network platform 106 includes shared system resources 132, communications interface 134, and/or one or more data stores that include non-transitory computer-readable storage media, such as storage 136. Shared system resources 132 may include one or more electronic processors, one or more graphics processing units, volatile computer memory, non-volatile computer memory, and/or one or more system buses connecting components of shared system resources 132, communications interface 134, and/or storage 136. In some examples, storage 136 includes one or more software modules, such as assessment module 138 and/or machine learning module 140. Additional functionality of assessment module 138 and machine learning module 140 will be described further on in this specification with reference to FIGS. 2-9B.

In some embodiments, issuer platform 108 includes shared system resources 142, communications interface 144, and/or one or more data stores that include non-transitory computer-readable storage media, such as storage 146. Shared system resources 142 may include one or more electronic processors, one or more graphics processing units, volatile computer memory, non-volatile computer memory, and/or one or more system buses connecting components of shared system resources 142, communications interface 144, and/or storage 146. In various implementations, storage 146 includes one or more software modules, such as assessment module 148 and/or machine learning module 150. Additional functionality of assessment module 148 and machine learning module 150 will be described further on in this specification with reference to FIGS. 2-9B.

Components of user device 102, merchant platform 104, payment network platform 106, and/or issuer platform 108 may communicate with each other via communications system 110. For example, components of user device 102 may communicate with communications system 110 via communications interface 114, components of merchant platform 104 may communicate with communications system 110 via communications interface 124, components of payment network platform 106 may communicate with communications system 110 via communications interface 134, and/or components of issuer platform 108 may communicate with communications system 110 via communications interface 144.

FIG. 2 is an example graphical user interface 200 generated by merchant platform 104. In an online transaction, the user may browse a merchant's website or app on user device 102. For example, merchant platform 104 generates graphical user interface 200 via user interface module 128, and the user accesses graphical user interface 200 via web browser 118 and/or merchant application 120. In various implementations, graphical user interface 200 represents a check-out page of an online storefront. Graphical user interface 200 may include one or more interactive user interface elements, such as fillable fields, drop-down menus, and/or buttons. In some examples, users may select any of the interactive user interface elements with a keyboard, mouse, trackpad, and/or by interacting with a touchscreen, depending on the nature of user device 102. After selecting one of the fillable fields (such as fields 202-228), users may enter a text string into the selected fillable field. After selecting one of the drop-down menus (such as menu 216), users may select one or more of the options of the selected drop-down menu. After populating fillable fields and/or drop-down menus, users may select button 230 to submit the transaction request or button 232 to exit from the check-out page.

In various implementations, metadata module 130 tracks user interactions with graphical user interface 200 and saves information related to the user interactions as behavioral biometric metadata. For example, the behavioral biometric metadata may include keystroke metadata. Keystroke metadata may be captured based on typing patterns as the user inputs text into the fillable fields. Keystroke metadata may include keystroke dynamics metadata, typing speed metadata, error rates and corrections metadata, key combinations metadata, special keys usage metadata, and/or sequence of keystrokes metadata. Examples of keystroke dynamics metadata include the time between pressing and releasing a key (dwell time) and/or the time between pressing one key and pressing the next key (flight time). Examples of typing speed metadata include the average speed at which a user types. Examples of error rates and corrections metadata include the frequency with which the user makes typing errors, as well as the ways in which they correct those errors (for example, whether they use the Backspace or Delete keys, or whether they highlight incorrect text and type over the text). Examples of key combinations metadata include whether the user uses certain key combinations to interact with graphical user interface 200, such as Ctrl+C for copy and Ctrl+V for paste and/or using the tab key to switch between fields. Examples of special keys usage metadata include whether the user uses special keys like Shift, Control, Alt, and/or the function keys. Examples of sequence of keystrokes metadata includes the specific sequence of keys the user presses as they interact with graphical user interface 200.

Behavioral biometric metadata may also include touchscreen, mouse, and/or trackpad metadata. For example, touchscreen metadata include tap metadata, long press metadata, swipe metadata, pinch and spread metadata, rotation metadata, scroll metadata, flick metadata, touch force metadata, touch side metadata, and/or sequences of interactions metadata. Examples of tap metadata include the location, timing, and/or frequency of taps on the touchscreen of user device 102. Examples of long press metadata include the location and/or duration of long presses on the touchscreen of user device 102. Examples of swipe metadata include the direction, speed, distance, and/or path of swipes across the touchscreen of user device 102. Examples of pinch and spread metadata include the scale, speed, and location of multi-touch gestures used to zoom in (spread) or out (pinch) on the touchscreen of user device 102. Examples of rotation metadata include the angle, speed, and/or location of using multiple fingers on the touchscreen of user device 102 to rotate graphical user interface 200. Examples of scroll metadata include the direction, speed, and/or distance of scrolls on the touchscreen of user device 102. Examples of flick metadata include the direction, speed, and/or distance of flicks on the touchscreen of user device 102. Examples of touch force metadata include the amount of force applied during a touch interaction on the touchscreen of user device 102. Examples of touch size metadata include the size of the contact area on the touchscreen of user device 102 (for example, touching the touchscreen with the tip of a finger can result in a smaller contact area than touching the touchscreen with the pad of a thumb). Sequences of interactions metadata include the combinations of interactions used to interact with graphical user interface 200.

In various implementations, mouse and/or trackpad metadata include movement patterns metadata, clicks metadata, scrolling metadata, hover time metadata, distance traveled metadata, dwell time metadata, exit movements metadata, and/or start and end points metadata. Examples of movement patterns metadata include the paths that a mouse takes across graphical user interface 200, the speed and acceleration of the mouse, and/or any patterns of movement (such as circling or zig-zagging). Examples of clicks metadata include the number, location, and/or timing of mouse clicks on graphical user interface 200. Left clicks, right clicks, double clicks, and/or clicks-and-drags may also be included in clicks metadata. Examples of scrolling metadata include whether the user scrolls with the mouse wheel or by clicking and dragging a scrollbar. The speed and direction of scrolling as well as the timing and frequency of scrolling may also be included in scrolling metadata. Examples of hover time metadata include the amount of time the mouse pointer stays in one play and/or where the user hovers their mouse pointer (for example, over an area of interest or text as they are reading the text). Examples of distance traveled metadata include the total length of the path a mouse cursor travels over a session. Examples of dwell time metadata includes the amount of time the mouse cursor stays within a specific area or element of graphical user interface 200, such as over a particular field, drop-down menu, and/or button. Examples of exit movements metadata include the movements a mouse cursor makes just before the user leaves a page. For example, the mouse cursor may move towards the top right corner of the screen if the user is about to close a window. Examples of start and end points metadata include the starting point and end point of the mouse cursor.

In some embodiments, behavioral biometric metadata may also include accelerometer and/or gyroscope metadata. Examples of accelerometer and/or gyroscope metadata include an orientation of the user device 102, linear movements of the user device 102 (such as whether it's moving up, down, left, right, forwards, and/or backwards), and/or rotation of the user device 102. In various implementations, behavioral biometric metadata may also include form navigation patterns metadata. Examples of form navigation patterns metadata include when the user clicks into a particular field, when the user exits the field, and/or how long the user spends in the field. In some implementations, the behavioral biometric metadata may be tracked and/or logged at the user device 102. In other implementations, the behavioral biometric metadata may be tracked and/or logged at merchant platform 104. In some examples, the behavioral biometric metadata may be tracked and/or logged at user device 102 and merchant platform 104.

In various implementations, behavioral biometric metadata may be logged from the beginning of a user's session until the end. In some examples, the session begins when the user starts interacting with the graphical user interface and ends when the intended actions are completed (for example, upon the user clicking a submission button on the graphical user interface). In various implementations, the session may also end after a period of time passes during which there are no interactions.

In some embodiments, the behavioral biometric metadata may be represented as a compact signature. For example, the user's interactions with the graphical user interfaces (e.g., mouse movements, clicks, keystrokes, scrolling data, and/or any of the previously described interactions) are initially logged as raw user interaction data. The raw user interaction data may be preprocessed to prepare the raw user interaction data for feature extraction. For example, preprocessing steps may include data cleaning (to remove any corrupted or incomplete records) and/or noise reduction (to remove outliers). Features may then be extracted from the preprocessed user interaction data. In various implementations, simple features such as a number of clicks, average typing speed, and/or time spent on different parts on the graphical user interface. In some examples, complex features such as patterns of mouse movement, click paths, and/or typing patterns could be extracted. In some embodiments, temporal features such as time of day, duration of a session, and/or the interval between specific actions could be extracted. In various implementations, spatial features such as favored positions for mouse clicks and/or areas of the graphical user interface that the user interacts with most often may be extracted.

After features are extracted from the preprocessed user interaction data, a signature may be generated from the extracted features. In various implementations, a data reduction process is used to transform the extracted features into a more compact form that captures key aspects of the user's behavior. For example, extracted features may be transformed into a signature using dimensionality reduction techniques such as principal component analysis or t-distributed stochastic neighbor embedding. In other examples, extracted features may be transformed into the signature using clustering techniques such as k-means clustering algorithms or density-based clustering algorithms. In various implementations, extracted features may be transformed into the signature using deep learning techniques. For example, autoencoders can be used to generate a lower-dimensional representation of the extracted features. In various implementations, the generated signatures may be normalized. For example, the signatures may be scaled so that the signatures may have the same, similar, or comparable magnitudes across all users of the system 100.

Representing behavioral biometric metadata as compact signatures offers a variety of technical benefits. For example, logged raw user interactions may have very large file sizes. Thus, transmitting logged raw user interactions as the behavioral biometric metadata may require large data payloads to be constantly transmitted across components of the system 100, which introduces latency into the data transmission process and may be computationally intensive. Furthermore, logged raw user interactions could potentially include sensitive data (for example, data that could potentially be reconstructed to generate user login credentials and/or personal user information). Representing logged raw user interactions as compact signatures reduces data transmission and computational requirements of the system 100 and increases the security of the system 100 by protecting sensitive user data from being compromised.

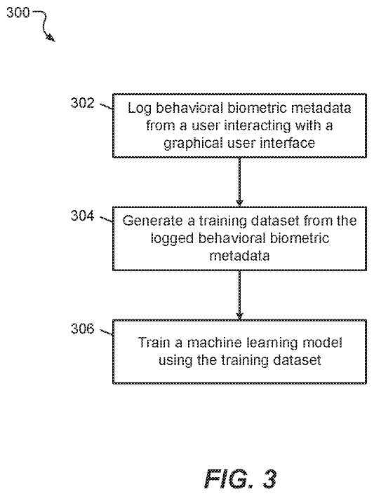

FIG. 3 is a flowchart of an example process 300 for training a machine learning model using behavioral biometric metadata. At 304, payment network platform 106 logs behavioral biometric metadata from a user interacting with a graphical user interface. For example, payment network platform 106 logs behavioral biometric metadata received from merchant platform 104. In various implementations, the behavioral biometric metadata includes an identifier that links the metadata to a particular user. For example, the identifier may include a credit card number, an account identifier (such as an email address and/or username), and/or a unique alphanumeric identifier. In some examples, payment network platform 106 continuously logs behavioral biometric metadata received from one or more transactions across one or more payment network platforms. In various implementations, payment network platform 106 continuously logs behavioral biometric metadata from the user's interactions with multiple graphical user interfaces on one or more payment network platforms. In various implementations, payment network platform 106 continuously logs behavioral biometric metadata from the user's interactions with multiple graphical user interfaces on multiple payment network platforms.

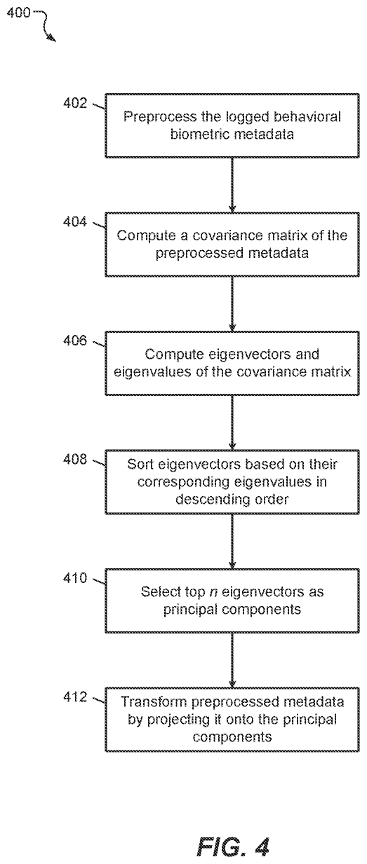

At 304, machine learning module 140 generates a training dataset from the logged behavioral biometric metadata. Additional details associated with generating the training dataset will be described further on in this specification with reference to FIG. 4.

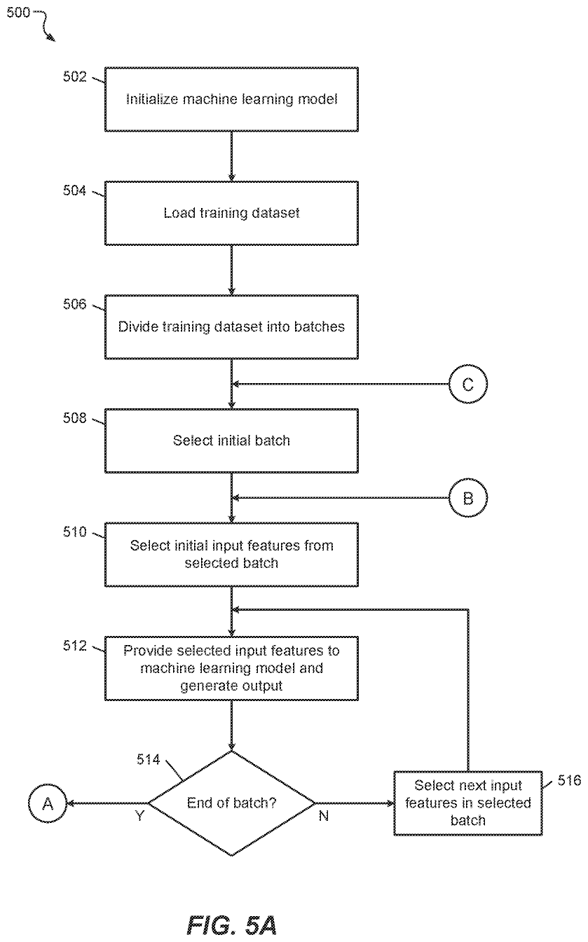

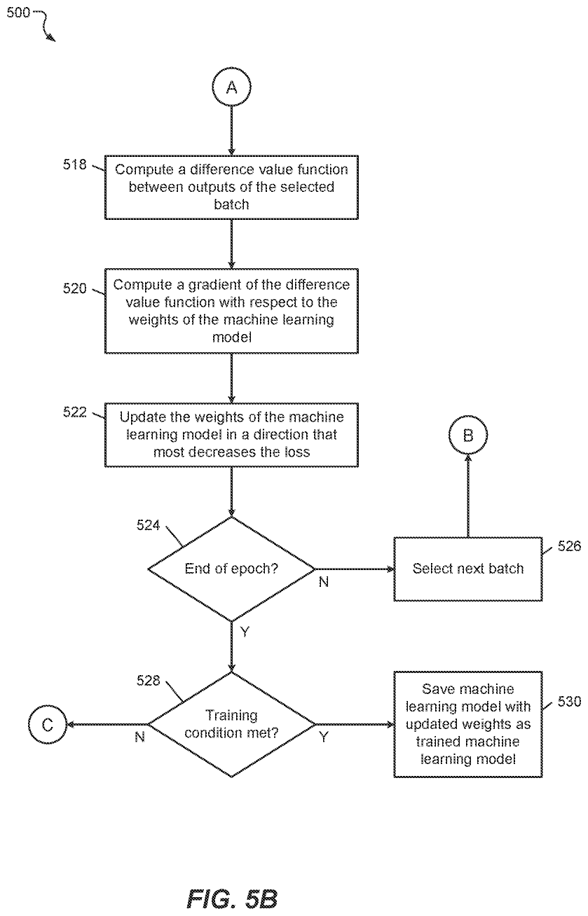

At 306, machine learning module 140 trains a machine learning model using the training dataset. Additional details associated with generating the training dataset will be described further on in this specification with reference to FIGS. 5A-5B.

FIG. 4 is a flowchart of an example process 400 for generating a training dataset from logged behavioral biometric metadata. At 402, machine learning module 140 preprocesses the logged behavioral biometric metadata. In various implementations, the logged behavioral biometric metadata is transformed into scalars, vectors, arrays, and/or tensors suitable for input to the machine learning model. The logged biometric metadata is then normalized and/or standardized.

At 404, machine learning module 140 computes a covariance matrix of the preprocessed metadata. In some embodiments, the covariance matrix is a square matrix that captures the variance of each feature in the preprocessed metadata as well as the covariance (such as how much they vary together) between each pair of features.

At 406, machine learning module 140 computes eigenvectors and eigenvalues of the covariance matrix. In some examples, the eigenvectors represent directions or components in the feature space, and the eigenvalues represent the magnitude or amount of variance of each component.

At 408, machine learning module 140 sorts the eigenvectors in descending order (based on the magnitude of their corresponding eigenvalues). This ranks the components in order of importance.

At 410, machine learning module 140 selects the top n eigenvectors as principal components. At 412, machine learning module 140 transforms the preprocessed metadata by projecting it onto the principal components. This transforms the preprocessed metadata into a new dataset having n features (instead of the original number of features). The new dataset is saved as the training dataset.

FIGS. 5A-5B are flowcharts of an example process 500 for training a machine learning model using the training dataset. At 502, machine learning module 140 initializes the machine learning model. In examples where the machine learning model includes a neural network machine learning module 140 initializes the weights for the connections between nodes of the neural network with small random values.

At 504, machine learning module 140 loads the training dataset. In various implementations, the training dataset may include behavioral biometric metadata associated with a single user. At 506, machine learning module 140 divides the training dataset into one or more batches.

At 508, machine learning module 140 selects the initial batch. At 510, machine learning module 140 selects initial input features from the selected batch. At 512, machine learning module 140 provides the selected input features to the machine learning model and generates an output.

At 514, machine learning module 140 determines whether the end of the batch has been reached. In response to determining that the end of the batch has not been reached (“NO” at decision block 514), machine learning module 140 selects the next input features in the selected batch at block 516 and proceeds back to block 512. In response to determining that the end of the batch has been reached (“YES” at decision block 514), machine learning module 140 computes a difference value function between outputs of the selected batch (at block 518). In various implementations, the difference value function calculates a difference (or closeness) between each of the output values in the batch. For example, if the output values are very different, the difference value function could converge on a first value. If the output values are very similar, the difference value function could converge on a second value. In various implementations, the first value could be 0 and the second value could be 1. In some embodiments, the first value could be 1 and the second value could be 0.

At 520, machine learning module 140 computes a gradient of the average loss function with respect to the weights. At 522, machine learning module 140 updates the weights of the machine learning model in a direction so that the difference value function converges on the second value. For example, machine learning module 140 uses an optimization algorithm such as gradient descent. If the learning rate is represented by n, then an example weight update rule may be represented by equation (1) below:

$$weight = weight - η \cdot gradient \qquad ( 1 )$$

At 524, machine learning module 140 determines whether the end of the epoch has been reached. In various implementations, the epoch is represented by the entirety of the training dataset, and so the end of the epoch is reached after each set of input features has been processed. In response to determining that the end of the epoch has not been reached (“NO” at decision block 524), machine learning module 140 selects the next batch at 526 and proceeds again to block 510. In response to determining that the end of the epoch has been reached (“YES” at decision block 524), machine learning module 140 determines whether a training condition has been met. In various implementations, the training condition may be met when the closeness between output values for a given batch or the entire epoch exceeds a threshold. In various implementations, the training condition may be met when the machine learning module 140 has processed a predefined number of epochs. In response to determining that the training condition has been met (“YES” at decision block 528), machine learning module 140 saves the machine learning model with the updated weights as the trained machine learning model at 530. In response to determining that the training condition has not been met (“NO” at decision block 528), machine learning module 140 again selects the initial batch of the training dataset at block 510.

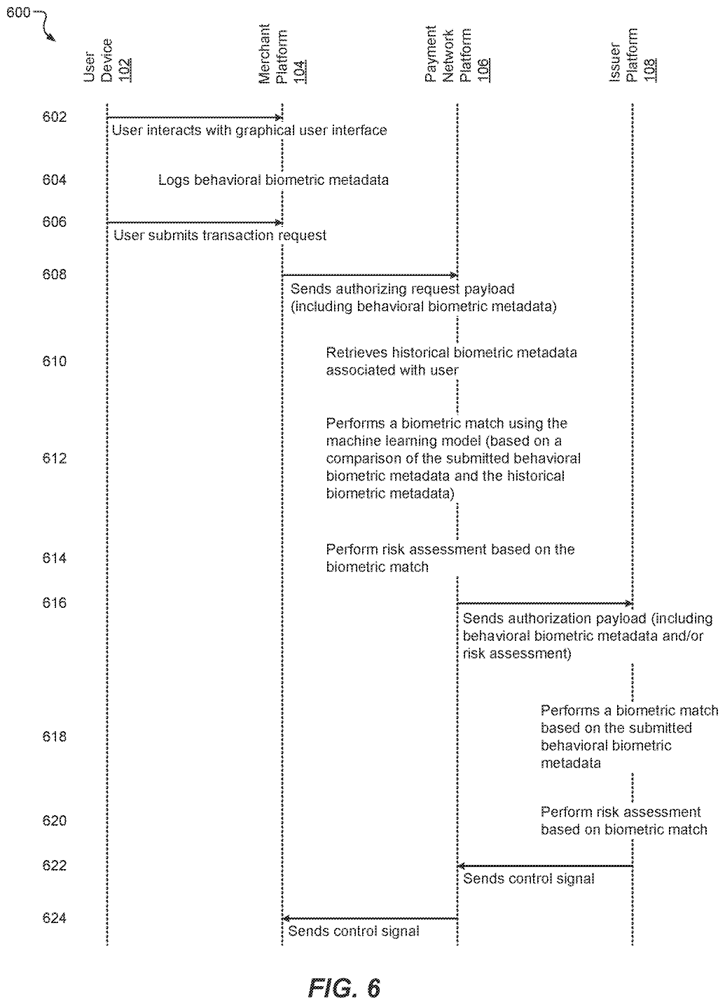

FIG. 6 is a message sequence chart 600 showing example interactions between components of the system 100 as the system 100 authenticates a transaction based on behavioral biometric metadata. At 602, user device 102 interacts with a graphical user interface generated by merchant platform 104. For example, the graphical user interface may be a check-out screen of an online storefront generated by user interface module 128 (such as represented by graphical user interface 200), and the user accesses the graphical user interface via web browser 118 and/or merchant application 120. The user may interact with elements of the graphical user interface using one or more of a touchscreen, keyboard, mouse, and trackpad.

At 604, merchant platform 104 generates behavioral biometric metadata generated by the user's interactions and logs the behavioral biometric metadata. In various implementations, metadata module 130 logs the user's interactions with the various user interface elements and saves the interactions as the behavioral biometric metadata.

At 606, user device 102 submits the transaction request to merchant platform 104. For example, after the user has populated the necessary fields and/or drop-down menus on graphical user interface 200, the user selects a user interface element (such as button 230) to submit the data in the populated fields and/or drop-down menus as the transaction request. As previously described, in some examples, behavioral biometric metadata may be logged at user device 102 and transmitted to merchant platform 104 along with the transaction request (for example, along with payment information).

At 608, merchant platform sends an authorizing request payload (which includes the behavioral biometric metadata logged at user device 102 and/or metadata module 130 of merchant platform 104) to payment network platform 106. At 610, payment network platform 106 retrieves historical biometric metadata associated with the user. For example (as previously described), the authorizing request payload transmitted from merchant platform 104 to payment network platform 106 may include an identifier linking the behavioral biometric metadata to a user, and payment network platform 106 retrieves historical biometric metadata associated with the identifier. In some examples, payment network platform 106 retrieves behavioral biometric metadata based linked to the payment information contained in the transaction request. In some examples, historical biometric metadata may be organized into profiles, with each profile corresponding to a specific user (and identifiable by its associated identifier-such as credit card number, account identifier, and/or unique alphanumeric identifier).

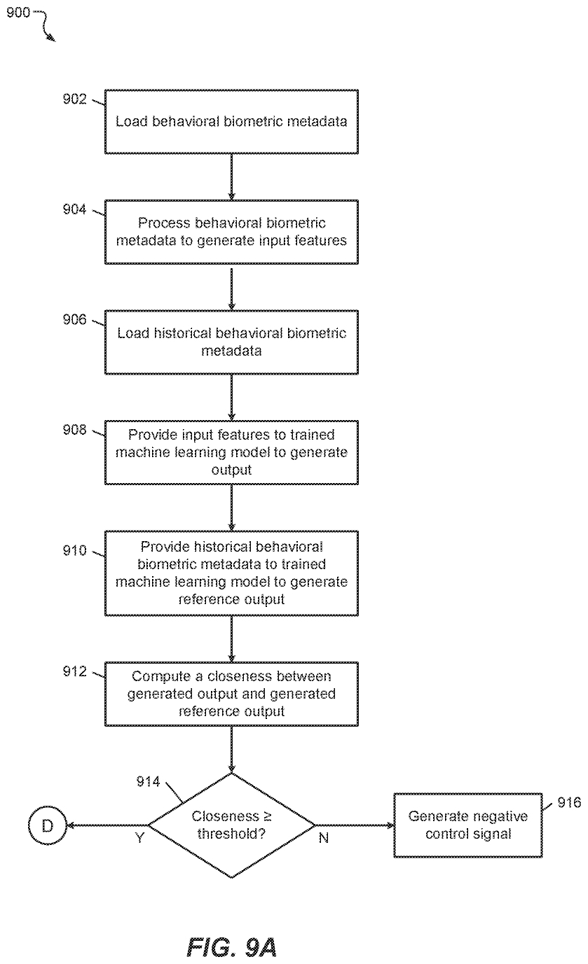

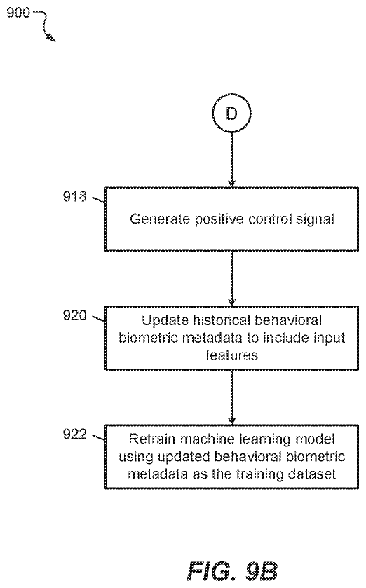

At 612, machine learning module 140 performs a biometric match using the trained machine learning model. For example, machine learning module 140 provides (i) the behavioral biometric metadata (included in the authorizing request payload) to the trained machine learning model to generate an output and (ii) provides the historical biometric metadata to the trained machine learning model to generate a reference output. Machine learning module 140 compares the output against the reference output and generates a closeness score. The biometric match may be determined based on the closeness score. For example, payment network platform 106 may determine that there is a biometric match in response to the closeness score being above a threshold. Conversely, payment network platform 106 may determine that there is not a biometric match in response to the closeness score being below a threshold. In some examples, the closeness score may be output as the biometric match. Additional details associated with performing a biometric match using the machine learning model (based on a comparison of the submitted behavioral biometric metadata and the historical biometric metadata) will be described further on in this specification with reference to FIGS. 9A-9B.

At 614, assessment module 138 performs a risk assessment based on the biometric match. For example, the risk assessment may include a likelihood of the user interacting with graphical user interface 200 at user device 102 is the same user that owns the payment method used in the transaction. At 616, payment network platform 106 sends an authorization payload (which includes the behavioral biometric metadata generated by the user during the transaction request and/or the risk assessment) to issuer platform 108. In some examples, machine learning module 150 performs a biometric match using a trained machine learning model based on the submitted behavioral biometric metadata at 618 (for example, according to the previously discussed principles and/or according to principles that will be described further on in this specification with reference to FIGS. 9A-9B).

At 620, issuer platform 108 performs a risk assessment based on the biometric match. For example, assessment module 148 determines whether to allow the transaction to proceed based on the biometric match. In some examples, assessment module 148 determines that the transaction should proceed in response to the biometric match meeting or exceeding a threshold. In some implementations, assessment module 148 determines that the transaction should not proceed in response to the biometric match being below the threshold. In some examples, assessment module 148 generates a positive control signal (for example, allowing the transaction to proceed) in response to the biometric match meeting or exceeding the threshold. In some embodiments, assessment module 148 generates a negative control signal (for example, not allowing the transaction to proceed) in response to the biometric match being below the threshold.

At 622, issuer platform 108 sends the control signal to payment network platform 106. Payment network platform 106 generates a positive control signal allowing the transaction to proceed (in response to receiving a positive control signal from issuer platform 108) or generates a negative control signal not allowing the transaction to proceed (in response to receiving a negative control signal from issuer platform 108). At 624, payment network platform 106 sends the generated control signal to merchant platform 104. Merchant platform 104 completes the transaction in response to receiving a positive control signal from payment network platform 106 or denies the transaction in response to receiving a negative control signal from payment network platform 106.

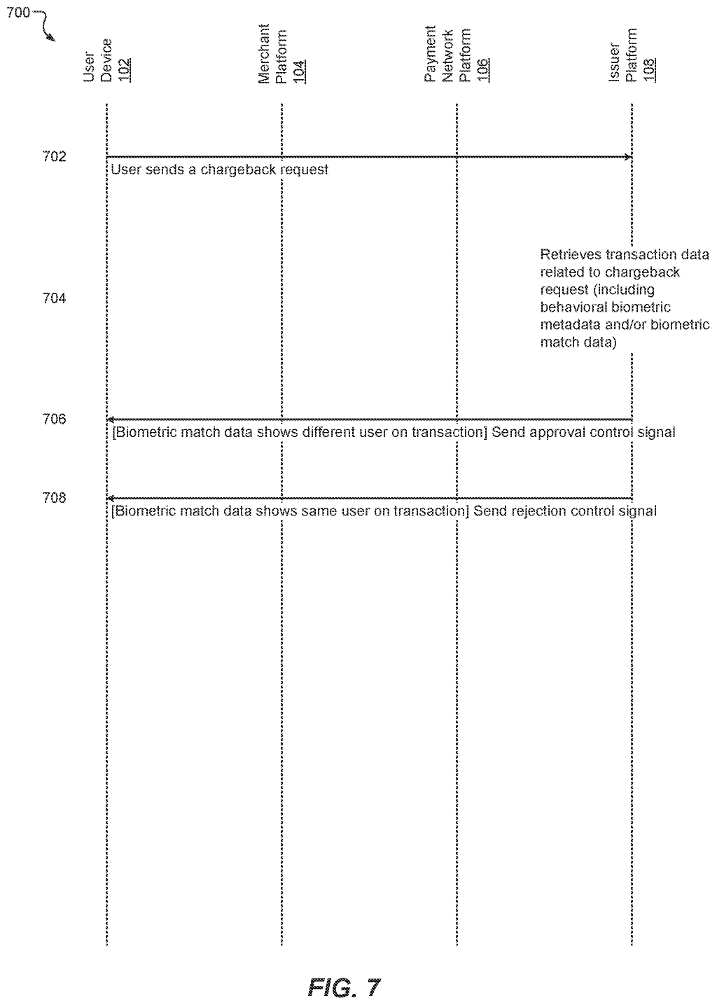

FIG. 7 is a message sequence chart 700 showing example interactions between components of the system 100 as the system 100 authenticates a chargeback request using behavioral biometric metadata. At 702, user device 102 sends a chargeback request to issuer platform 108. For example, the user interacts with a graphical user interface generated by issuer platform 108 via web browser 118.

At 704, issuer platform 108 retrieves transaction data related to the chargeback request. In various implementations, the retrieved transactional data includes biometric match data associated with the transaction related to the chargeback request. Assessment module 148 determines whether the retrieved biometric match data indicated a match for the transaction related to chargeback request. In response to the retrieved biometric match data not indicating a match, issuer platform 108 approves the chargeback request and sends an approval control signal to user device 102 at 706. In response to the retrieved biometric match data indicating a match, issuer platform 108 denies the chargeback request and sends a rejection control signal to user device 102 at 708.

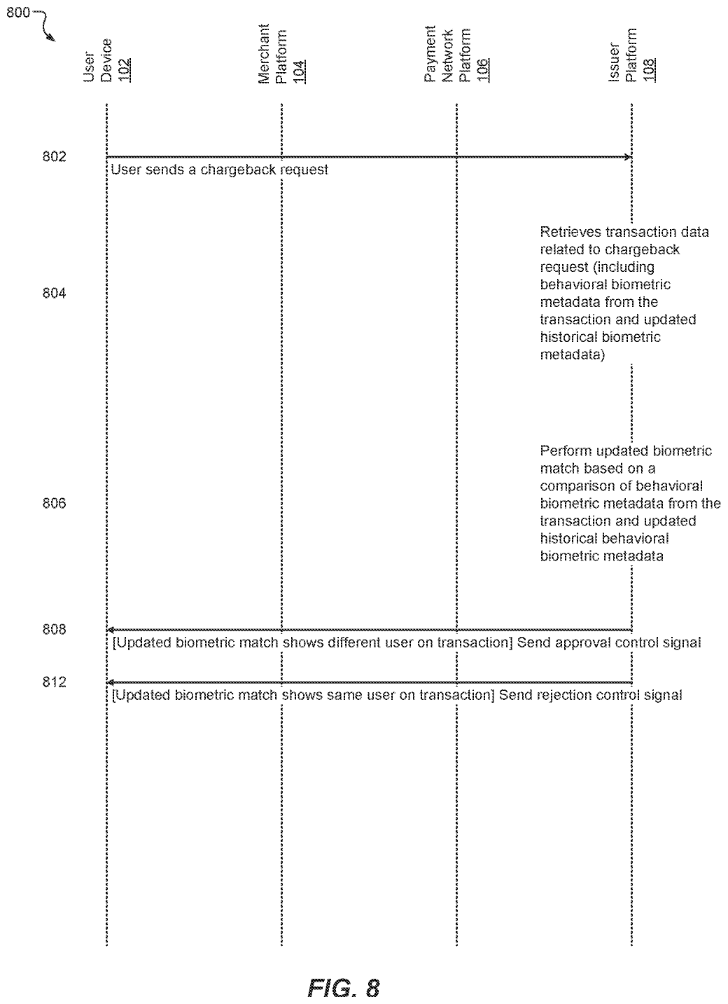

FIG. 8 is a message sequence chart 800 showing example interactions between components of the system 100 as the system 100 authenticates a chargeback request using behavioral biometric metadata. At 802, user device 102 sends a chargeback request to issuer platform 108.

At 804, issuer platform 108 retrieves transactional data related to the chargeback request. In some embodiments, the retrieved transaction data includes behavioral biometric metadata from the transaction and updated historical behavioral biometric metadata. For example, in cases where the transaction related to the chargeback request occurred prior to the chargeback request, historical behavioral biometric metadata related to the user requesting the chargeback could have been updated with additional behavioral biometric metadata (for example, from additional transactions that may have taken place between the original transaction and the chargeback request).

At 806, machine learning module 150 performs an updated biometric match based on a comparison between the behavioral biometric metadata from the transaction and the updated historical behavioral biometric metadata. Machine learning module 150 may perform the updated biometric match according to principles previously discussed or principles discussed further on in this specification with reference to FIGS. 9A-9B.

Assessment module 148 determines whether the updated biometric match meets or exceeds a threshold. In response to the updated biometric match not meeting or exceeding the threshold, assessment module 148 determines that a different user submitted the original transaction and sends an approval control signal to user device 102 (approving the chargeback request) at 810. In response to the updated biometric match meeting or exceeding the threshold, assessment module 148 determines that the same user submitted the original transaction and sends a rejection control signal to user device 102 (denying the chargeback request) at 812.

FIGS. 9A-9B are flowcharts of an example process 900 for performing a biometric match using a machine learning model. At 902, a machine learning module (such as machine learning module 140 and/or machine learning module 150) loads behavioral biometric metadata. In various implementations, the behavioral biometric metadata may be related to a given transaction.

At 904, the machine learning module processes the behavioral biometric metadata to generate input features for a trained machine learning model. At 906, the machine learning module loads historical behavioral biometric metadata.

At 908, the machine learning module provides the input features to the trained machine learning model to generate an output. At 910, the machine learning module provides the loaded historical behavioral biometric metadata to the trained machine learning model to generate a reference output. At 912, the machine learning module calculates a closeness between the generated output and the generated reference output.

In response to the closeness being below a threshold (“NO” at decision block 914), an assessment module (such as assessment module 138 and/or assessment module 148) generates a negative control signal at 916. In response to the closeness being at or above the threshold (“YES” at decision block 914), the assessment module generates a positive control signal at 918.

At 920, the machine learning module updates the historical behavioral biometric metadata to include the input features (e.g., representing behavioral biometric metadata from the current transaction). At 922, the machine learning module retrains the machine learning model using the updated behavioral biometric metadata as the training dataset (for example, according to principles previously described with reference to FIGS. 5A-5B).

Systems and techniques described in this specification provide a variety of novel and inventive solutions to technical problems related to detecting fraudulent transactions that can scale across a wide range of different devices, software, and merchant platforms. For example, given the sheer variety of devices, software, and merchant platforms, it is impractical to build a set of rules adequately covering every combination of usage pattern (much less updating the rules as usage patterns change). Because systems and techniques described in this specification are not rules based, they are standardizable and scalable across any number of user devices, software types and versions, and merchant platforms. Additionally, in some examples, payment network platform 106 aggregates historical behavioral biometric data from the user's interactions with a variety of graphical user interfaces across a variety of merchant platforms. Thus, biometric matches for each transaction are performed against a much more robust set of historical behavioral biometric data than historical behavioral biometric data generated at an individual merchant-platform level or from the user's interactions with a single graphical user interface.

Furthermore, because historical behavioral biometric metadata is continuously collected and updated every time the user generates a transaction (regardless of which device, software, or merchant platform the user interacts with—or whether the device, software, or merchant platform is new or different from those used in previous interactions), the historical behavioral biometric metadata is constantly being updated to incorporate the user's most up-to-date habits and patterns. Additionally, because biometric matches are performed passively behind-the-scenes, authentication protocols incorporating systems and techniques described in this specification offer a seamless experience to both the user and merchant platform. Finally, techniques described in this specification are computationally lightweight and may be performed in real time or near-real time.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more steps within any given method may be executed in a different order—or steps may be executed concurrently—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. However, the direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element.

Throughout this application, the term “module” or the term “controller” may be replaced with the term “circuit.” A “module” may refer to, be part of, or include processor hardware that executes code and memory hardware that stores code executed by the processor hardware. The term “module” may include one or more interference circuits. In various implementations, the interference circuits may implement wired or wireless interfaces that connect to or are part of communications systems. Modules may communicate with other modules using the interference circuits. In various implementations, the functionality of modules may be distributed among multiple modules that are connected via communications systems. For example, functionality may be distributed across multiple modules by a load balancing system. In various implementations, the functionality of modules may be split between multiple computing platforms connected by communications systems.

The term “code” may include software, firmware, and/or microcode, and may refer to programs, routines, functions, classes, data structures, and/or data objects. The term “memory hardware” may be a subset of the term “computer-readable medium.” The term computer-readable medium does not encompass transitory electrical or electromagnetic signals or electromagnetic signals propagating through a medium-such as on an electromagnetic carrier wave. The term “computer-readable medium” is considered tangible and non-transitory. Modules, methods, and apparatuses described in this application may be partially or fully implemented by a special-purpose computer that is created by configuring a general-purpose computer to execute one or more particular functions described in computer programs. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device, or they may be distributed among different computing devices-such as computing devices interconnected by one or more networks or other communications systems.

In the claims, if an apparatus or system is claimed as including an electronic processor or other element configured in a certain manner, the claim or claimed element should be interpreted as meaning one or more electronic processors (or another element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

What is claimed is:

1. A system including:
memory hardware configured to store instructions and
one or more electronic processors configured to execute the instructions, wherein the instructions include:
receiving historical behavioral biometric metadata from a plurality of computing platforms to build a historical profile,
training a machine learning model using the historical profile,
receiving a transaction request from a first computing platform, the transactional request including first behavioral biometric metadata,
providing the first behavioral biometric metadata and the historical behavioral biometric metadata to the trained machine learning model to generate a biometric match,
generating a control signal based on the biometric match, and
sending the control signal to a second computing platform.

2. The system of claim 1 wherein the instructions include:
updating the historical profile using the first behavioral biometric metadata and
retraining the trained machine learning model using the updated historical profile.

3. The system of claim 1 wherein providing the first behavioral biometric metadata and the historical behavioral biometric metadata to the trained machine learning model to generate the biometric match includes:
providing the first behavioral biometric metadata to the trained machine learning model to generate a first output;
providing the historical profile to the trained machine learning model to generate a reference output; and
computing a closeness of the first output and the reference output.

4. The system of claim 3 wherein providing the first behavioral biometric metadata and the historical behavioral biometric metadata to the trained machine learning model to generate the biometric match includes:
in response to the closeness not exceeding a threshold, generating a negative biometric match.

5. The system of claim 4 wherein providing the first behavioral biometric metadata and the historical behavioral biometric metadata to the trained machine learning model to generate the biometric match includes:
in response to the closeness meeting or exceeding the threshold, generating a positive biometric match.

6. The system of claim 1 wherein the instructions include retrieving the historical profile based on an identifier contained in the transactional request.

7. The system of claim 1 wherein the first behavioral biometric metadata includes keystroke metadata.

8. The system of claim 1 wherein the first behavioral biometric metadata includes touchscreen metadata.

9. The system of claim 1 wherein the first behavioral biometric metadata includes mouse metadata.

10. The system of claim 1 wherein the first behavioral biometric metadata includes accelerometer metadata.

11. A computer-implemented method comprising:
receiving historical behavioral biometric metadata from a plurality of computing platforms to build a historical profile;
training a machine learning model using the historical profile;
receiving a transaction request from a first computing platform, the transactional request including first behavioral biometric metadata;
providing the first behavioral biometric metadata and the historical behavioral biometric metadata to the trained machine learning model to generate a biometric match;
generating a control signal based on the biometric match; and
sending the control signal to a second computing platform.

12. The method of claim 11 including:
updating the historical profile using the first behavioral biometric metadata and
retraining the trained machine learning model using the updated historical profile.

13. The method of claim 11 wherein providing the first behavioral biometric metadata and the historical behavioral biometric metadata to the trained machine learning model to generate the biometric match includes:
providing the first behavioral biometric metadata to the trained machine learning model to generate a first output;
providing the historical profile to the trained machine learning model to generate a reference output; and
computing a closeness of the first output and the reference output.

14. The method of claim 13 wherein providing the first behavioral biometric metadata and the historical behavioral biometric metadata to the trained machine learning model to generate the biometric match includes:
in response to the closeness not exceeding a threshold, generating a negative biometric match.

15. The method of claim 14 wherein providing the first behavioral biometric metadata and the historical behavioral biometric metadata to the trained machine learning model to generate the biometric match includes:
in response to the closeness meeting or exceeding the threshold, generating a positive biometric match.

16. The method of claim 11 including retrieving the historical profile based on an identifier contained in the transactional request.

17. The method of claim 11 wherein the first behavioral biometric metadata includes keystroke metadata.

18. The method of claim 11 wherein the first behavioral biometric metadata includes touchscreen metadata.

19. The method of claim 11 wherein the first behavioral biometric metadata includes mouse metadata.

20. The method of claim 11 wherein the first behavioral biometric metadata includes accelerometer metadata.
